(19) United States
(12) Patent Application Publication
(10) Pub. No.: US 2025/0284584 A1
(43) Pub. Date: Sep. 11, 2025

(54) USER DATA BLOCK ERROR DETECTION AND CORRECTION

(71) Applicant: Micron Technology, Inc., Boise, ID (US)

(72) Inventor: Marco SFORZIN, Cernusco Sul Naviglio (IT)

(21) Appl. No.: 19/050,920

(22) Filed: Feb. 11, 2025

Related U.S. Application Data
(60) Provisional application No. 63/563,692, filed on Mar. 11, 2024.

(51) Int. Cl. G06F 11/10

(52) U.S. Cl. CPC G06F 11/1004

(57) ABSTRACT

In some implementations, a memory device may retrieve, via one or more data pins associated with a user data block, host data. The memory device may retrieve, via one or more data mask inversion pins associated with the user data block, error correction data. The memory device may detect, using the host data and the error correction data, one or more multi-bit errors in the host data. The memory device may correct, using the host data and the error correction data, the one or more multi-bit errors.

### CROSS-REFERENCE TO RELATED APPLICATION

This Patent application claims priority to U.S. Provisional Patent Application No. 63/563,692, filed on Mar. 11, 2024, entitled “USER DATA BLOCK ERROR DETECTION AND CORRECTION,” and assigned to the assignee hereof. The disclosure of the prior Application is considered part of and is incorporated by reference into this Patent Application.

### TECHNICAL FIELD

The present disclosure generally relates to memory devices, memory device operations, and, for example, to user data block error detection and correction.

### BACKGROUND

Memory devices are widely used to store information in various electronic devices. A memory device includes memory cells. A memory cell is an electronic circuit capable of being programmed to a data state of two or more data states. For example, a memory cell may be programmed to a data state that represents a single binary value, often denoted by a binary “1” or a binary “0.” As another example, a memory cell may be programmed to a data state that represents a fractional value (e.g., 0.5, 1.5, or the like). To store information, an electronic device may write to, or program, a set of memory cells. To access the stored information, the electronic device may read, or sense, the stored state from the set of memory cells.

Various types of memory devices exist, including random access memory (RAM), read only memory (ROM), dynamic RAM (DRAM), static RAM (SRAM), synchronous dynamic RAM (SDRAM), ferroelectric RAM (FeRAM), magnetic RAM (MRAM), resistive RAM (RRAM), holographic RAM (HRAM), flash memory (e.g., NAND memory and NOR memory), and others. A memory device may be volatile or non-volatile. Non-volatile memory (e.g., flash memory) can store data for extended periods of time even in the absence of an external power source. Volatile memory (e.g., DRAM) may lose stored data over time unless the volatile memory is refreshed by a power source. In some examples, a memory device may be associated with a compute express link (CXL). For example, the memory device may be a CXL compliant memory device and/or may include a CXL interface.

### BRIEF DESCRIPTION OF THE DRAWINGS

FIG. 1 is a diagram illustrating an example system capable of user data block error detection and correction.

FIGS. 2A-2E are diagrams of examples associated with error correction codes used to provide memory die failure protection.

FIGS. 3A-3I are diagrams of an examples associated with user data block error detection and correction.

FIG. 4 is a flowchart of an example method associated with user data block error detection and correction.

FIG. 5 is a diagram illustrating example systems in which the memory device described herein may be used.

### DETAILED DESCRIPTION

Memory devices may be capable of detecting and/or correcting errors in host data using an error correction code (ECC). In some examples, an ECC may be associated with parity information that, along with the host data, may be used to correct one or more errors. In some cases, such as cases in which host data is stored using multiple dies or similar components, such as by striping the host data across multiple data dies and/or by storing parity information at one or more parity dies, parity information may be capable of correcting errors in an event in which an entire die or similar component of a memory array fails, sometimes referred to herein as memory die failure protection. Although memory die failure protection schemes may improve a reliability of a memory device, such schemes may be resource-intensive and/or may result in die overprovisioning, performance penalties (e.g., reduced bandwidth and/or increased latency), and high power consumption.

Some implementations described herein enable error detection and correction schemes that are capable of mitigating failures in memory components without providing full memory die failure protection, and thus are less resource-intensive than memory die failure protection schemes. In some implementations, parity information or similar error correction information may be stored in a portion of a memory associated with one or more data mask inversion (DMI) pins. In this way, when performing a single access to a user data block (UDB) or a similar portion of memory, a memory controller may retrieve host data via one or more data pins (e.g., DQ pins) and parity data or similar error correction information via one or more DMI pins, and/or may detect and/or correct errors in the host data using the parity data. As a result, a memory device may avoid die overprovisioning typically associated with memory die failure protection schemes, may experience increased bandwidth and/or reduced latency as compared to memory devices employing memory die failure protection schemes, and/or may experience reduced power consumption as compared to memory devices employing more memory die failure protection schemes.

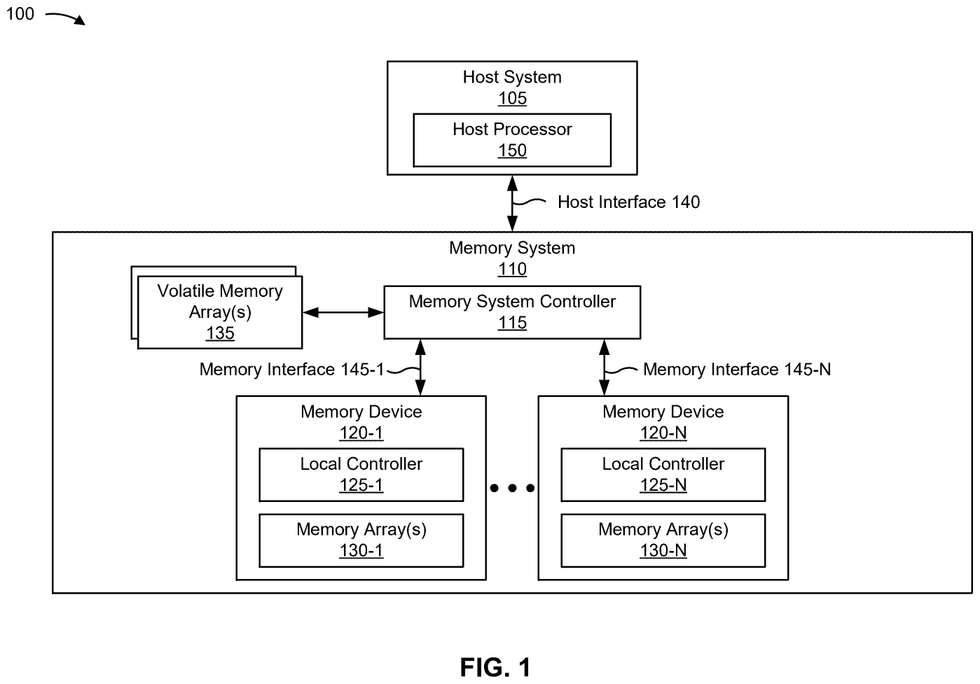

FIG. 1 is a diagram illustrating an example system 100 capable of user data block error detection and correction. The system 100 may include one or more devices, apparatuses, and/or components for performing operations described herein. For example, the system 100 may include a host system 105 and a memory system 110. The memory system 110 may include a memory system controller 115 and one or more memory devices 120, shown as memory devices 120-1 through 120-N (where N≥1). A memory device may include a local controller 125 and one or more memory arrays 130. The host system 105 may communicate with the memory system 110 (e.g., the memory system controller 115 of the memory system 110) via a host interface 140. The memory system controller 115 and the memory devices 120 may communicate via respective memory interfaces 145, shown as memory interfaces 145-1 through 145-N (where N≥1).

The system 100 may be any electronic device configured to store data in memory. For example, the system 100 may be a computer, a mobile phone, a wired or wireless communication device, a network device, a server, a device in a data center, a device in a cloud computing environment, a vehicle (e.g., an automobile or an airplane), and/or an Internet of Things (IoT) device. The host system 105 may include a host processor 150. The host processor 150 may include one or more processors configured to execute instructions and store data in the memory system 110. For example, the host processor 150 may include a central processing unit (CPU), a graphics processing unit (GPU), a field-programmable gate array (FPGA), an application-specific integrated circuit (ASIC), and/or another type of processing component.

The memory system 110 may be any electronic device or apparatus configured to store data in memory. For example, the memory system 110 may be a hard drive, a solid-state drive (SSD), a flash memory system (e.g., a NAND flash memory system or a NOR flash memory system), a universal serial bus (USB) drive, a memory card (e.g., a secure digital (SD) card), a secondary storage device, a non-volatile memory express (NVMe) device, an embedded multimedia card (eMMC) device, a dual in-line memory module (DIMM), and/or a random-access memory (RAM) device, such as a dynamic RAM (DRAM) device or a static RAM (SRAM) device.

The memory system controller 115 may be any device configured to control operations of the memory system 110 and/or operations of the memory devices 120. For example, the memory system controller 115 may include control logic, a memory controller, a system controller, an ASIC, an FPGA, a processor, a microcontroller, and/or one or more processing components. In some implementations, the memory system controller 115 may communicate with the host system 105 and may instruct one or more memory devices 120 regarding memory operations to be performed by those one or more memory devices 120 based on one or more instructions from the host system 105. For example, the memory system controller 115 may provide instructions to a local controller 125 regarding memory operations to be performed by the local controller 125 in connection with a corresponding memory device 120.

A memory device 120 may include a local controller 125 and one or more memory arrays 130. In some implementations, a memory device 120 includes a single memory array 130. In some implementations, each memory device 120 of the memory system 110 may be implemented in a separate semiconductor package or on a separate die that includes a respective local controller 125 and a respective memory array 130 of that memory device 120. The memory system 110 may include multiple memory devices 120.

A local controller 125 may be any device configured to control memory operations of a memory device 120 within which the local controller 125 is included (e.g., and not to control memory operations of other memory devices 120). For example, the local controller 125 may include control logic, a memory controller, a system controller, an ASIC, an FPGA, a processor, a microcontroller, and/or one or more processing components. In some implementations, the local controller 125 may communicate with the memory system controller 115 and may control operations performed on a memory array 130 coupled with the local controller 125 based on one or more instructions from the memory system controller 115. As an example, the memory system controller 115 may be an SSD controller, and the local controller 125 may be a NAND controller.

A memory array 130 may include an array of memory cells configured to store data. For example, a memory array 130 may include a non-volatile memory array (e.g., a NAND memory array or a NOR memory array) or a volatile memory array (e.g., an SRAM array or a DRAM array). In some implementations, the memory system 110 may include one or more volatile memory arrays 135. A volatile memory array 135 may include an SRAM array and/or a DRAM array, among other examples. The one or more volatile memory arrays 135 may be included in the memory system controller 115, in one or more memory devices 120, and/or in both the memory system controller 115 and one or more memory devices 120. In some implementations, the memory system 110 may include both non-volatile memory capable of maintaining stored data after the memory system 110 is powered off and volatile memory (e.g., a volatile memory array 135) that requires power to maintain stored data and that loses stored data after the memory system 110 is powered off. For example, a volatile memory array 135 may cache data read from or to be written to non-volatile memory, and/or may cache instructions to be executed by a controller of the memory system 110.

The host interface 140 enables communication between the host system 105 (e.g., the host processor 150) and the memory system 110 (e.g., the memory system controller 115). The host interface 140 may include, for example, a Small Computer System Interface (SCSI), a Serial-Attached SCSI (SAS), a Serial Advanced Technology Attachment (SATA) interface, a Peripheral Component Interconnect Express (PCIe) interface, an NVMe interface, a USB interface, a Universal Flash Storage (UFS) interface, an eMMC interface, a double data rate (DDR) interface, and/or a DIMM interface.

The memory interface 145 enables communication between the memory system 110 and the memory device 120. The memory interface 145 may include a non-volatile memory interface (e.g., for communicating with non-volatile memory), such as a NAND interface or a NOR interface. Additionally, or alternatively, the memory interface 145 may include a volatile memory interface (e.g., for communicating with volatile memory), such as a DDR interface.

In some examples, the memory system 110 may be a compute express link (CXL) compliant memory system (sometimes referred to herein simply as a CXL memory system) and/or one or more of the memory devices 120 may be CXL compliant memory devices (sometimes referred to herein simply as CXL memory devices). CXL is a high-speed CPU-to-device and CPU-to-memory interconnect designed to accelerate next-generation performance. CXL technology maintains memory coherency between the CPU memory space and memory on attached devices, which allows resource sharing for higher performance, reduced software stack complexity, and lower overall system cost. CXL is designed to be an industry open standard interface for high-speed communications. CXL technology is built on the PCIe infrastructure, leveraging PCIe physical and electrical interfaces to provide an advanced protocol in areas such as input/output (I/O) protocol, memory protocol, and coherency interface.

In some examples, the memory system 110 may include a PCIe/CXL interface (e.g., the host interface 140 may be associated with a PCIe/CXL interface), which may be a physical interface configured to connect the CXL memory system and/or the CXL memory device to CXL compliant host devices. In such examples, the PCIe/CXL interface may comply with CXL standard specifications for physical connectivity, ensuring broad compatibility and ease of integration into existing systems using the CXL protocol. Additionally, or alternatively, a CXL memory system and/or a CXL memory device may be designed to efficiently interface with computing systems (e.g., the host system 105) by leveraging the CXL protocol. For example, a CXL memory system and/or a CXL memory device may be configured to utilize high-speed, low-latency interconnect capabilities of CXL, such as for a purpose of making the CXL memory system and/or the CXL memory device suitable for high-performance computing, data center applications, artificial intelligence (AI) applications, and/or similar applications.

A CXL memory system and/or a CXL memory device may include a CXL memory controller (e.g., memory system controller 115 and/or local controller 125), which may be configured to manage data flow between memory arrays (e.g., volatile memory arrays 135 and/or memory arrays 130) and a CXL interface (e.g., a PCIe/CXL interface, such as host interface 140). In some examples, the CXL memory controller may be configured to handle one or more CXL protocol layers, such as an I/O layer (e.g., a layer associated with a CXL.io protocol, which may be used for purposes such as device discovery, configuration, initialization, I/O virtualization, direct memory access (DMA) using non-coherent load-store semantics, and/or similar purposes); a cache coherency layer (e.g., a layer associated with a CXL.cache protocol, which may be used for purposes such as caching host memory using a modified, exclusive, shared, invalid (MESI) coherence protocol, or similar purposes); or a memory protocol layer (e.g., a layer associated with a CXL.memory (sometimes referred to as CXL.mem) protocol, which may enable a CXL memory device to expose host-managed device memory (HDM) to permit a host device to manage and access memory similar to a native DDR connected to the host); among other examples.

A CXL memory system and/or a CXL memory device may further include and/or be associated with one or more high-bandwidth memory modules (HBMMs) or similar memory arrays (e.g., volatile memory arrays 135 and/or memory arrays 130). For example, a CXL memory system and/or a CXL memory device may include multiple layers of DRAM (e.g., stacked and/or interconnected through advanced through-silicon via (TSV) technology) in order to maximize storage density and/or enhance data transfer speeds between memory layers. Additionally, or alternatively, a CXL memory system and/or a CXL memory device may include a power management unit, which may be configured to regulate power consumption associated with the CXL memory system and/or the CXL memory device and/or which may be configured to improve energy efficiency for the CXL memory system and/or the CXL memory device. Additionally, or alternatively, a CXL memory system and/or a CXL memory device may include additional components, such as one or more ECC engines, such as for a purpose of detecting and/or correcting data errors to ensure data integrity and/or improve the overall reliability of the CXL memory system and/or the CXL memory device.

Although the example memory system 110 described above includes a memory system controller 115, in some implementations, the memory system 110 does not include a memory system controller 115. For example, an external controller (e.g., included in the host system 105) and/or one or more local controllers 125 included in one or more corresponding memory devices 120 may perform the operations described herein as being performed by the memory system controller 115. Furthermore, as used herein, a “controller” may refer to the memory system controller 115, a local controller 125, or an external controller. In some implementations, a set of operations described herein as being performed by a controller may be performed by a single controller. For example, the entire set of operations may be performed by a single memory system controller 115, a single local controller 125, or a single external controller. Alternatively, a set of operations described herein as being performed by a controller may be performed by more than one controller. For example, a first subset of the operations may be performed by the memory system controller 115 and a second subset of the operations may be performed by a local controller 125. Furthermore, the term “memory apparatus” may refer to the memory system 110 or a memory device 120, depending on the context.

A controller (e.g., the memory system controller 115, a local controller 125, or an external controller) may control operations performed on memory (e.g., a memory array 130), such as by executing one or more instructions. For example, the memory system 110 and/or a memory device 120 may store one or more instructions in memory as firmware, and the controller may execute those one or more instructions. Additionally, or alternatively, the controller may receive one or more instructions from the host system 105 and/or from the memory system controller 115, and may execute those one or more instructions. In some implementations, a non-transitory computer-readable medium (e.g., volatile memory and/or non-volatile memory) may store a set of instructions (e.g., one or more instructions or code) for execution by the controller. The controller may execute the set of instructions to perform one or more operations or methods described herein. In some implementations, execution of the set of instructions, by the controller, causes the controller, the memory system 110, and/or a memory device 120 to perform one or more operations or methods described herein. In some implementations, hardwired circuitry is used instead of or in combination with the one or more instructions to perform one or more operations or methods described herein. Additionally, or alternatively, the controller may be configured to perform one or more operations or methods described herein. An instruction is sometimes called a “command.”

For example, the controller (e.g., the memory system controller 115, a local controller 125, or an external controller) may transmit signals to and/or receive signals from memory (e.g., one or more memory arrays 130) based on the one or more instructions, such as to transfer data to (e.g., write or program), to transfer data from (e.g., read), to erase, and/or to refresh all or a portion of the memory (e.g., one or more memory cells, pages, sub-blocks, blocks, or planes of the memory). Additionally, or alternatively, the controller may be configured to control access to the memory and/or to provide a translation layer between the host system 105 and the memory (e.g., for mapping logical addresses to physical addresses of a memory array 130). In some implementations, the controller may translate a host interface command (e.g., a command received from the host system 105) into a memory interface command (e.g., a command for performing an operation on a memory array 130).

In some implementations, one or more systems, devices, apparatuses, components, and/or controllers of FIG. 1 may be configured to retrieve, via one or more data pins associated with a user data block, host data; retrieve, via one or more DMI pins associated with the user data block, error correction data; detect, using the host data and the error correction data, one or more multi-bit errors in the host data; and correct, using the host data and the error correction data, the one or more multi-bit errors.

In some implementations, one or more systems, devices, apparatuses, components, and/or controllers of FIG. 1 may be configured to, for each user data block of multiple user data blocks included in a media subsystem: retrieve, via one or more data pins associated with the user data block, host data; retrieve, via one or more DMI pins associated with the user data block, error correction data; detect, using the host data and the error correction data, one or more multi-bit errors in the host data; and correct, using the host data and the error correction data, the one or more multi-bit errors.

The number and arrangement of components shown in FIG. 1 are provided as an example. In practice, there may be additional components, fewer components, different components, or differently arranged components than those shown in FIG. 1. Furthermore, two or more components shown in FIG. 1 may be implemented within a single component, or a single component shown in FIG. 1 may be implemented as multiple, distributed components. Additionally, or alternatively, a set of components (e.g., one or more components) shown in FIG. 1 may perform one or more operations described as being performed by another set of components shown in FIG. 1.

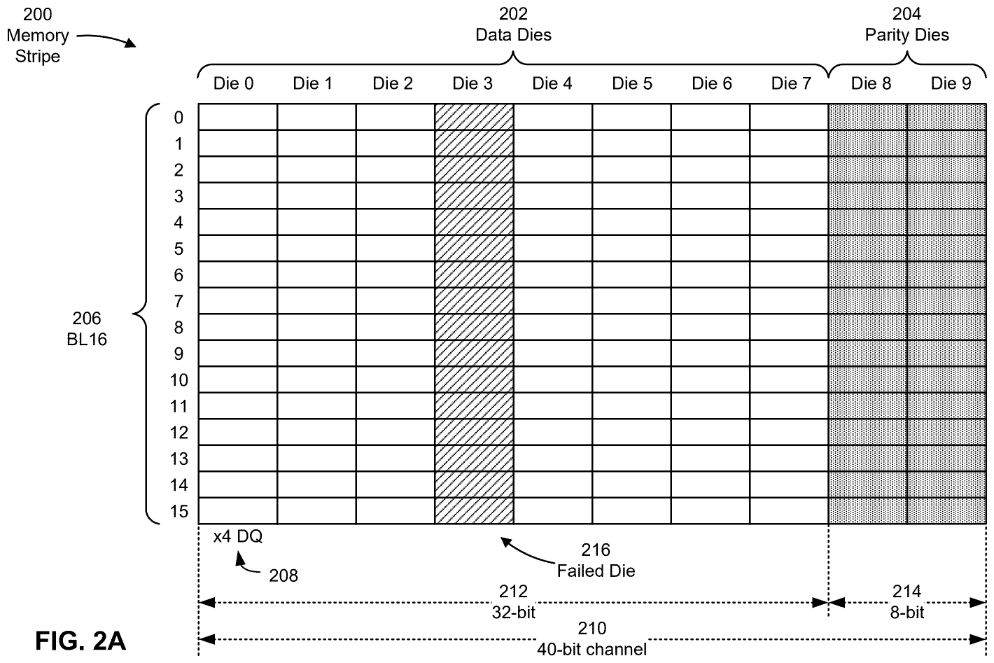

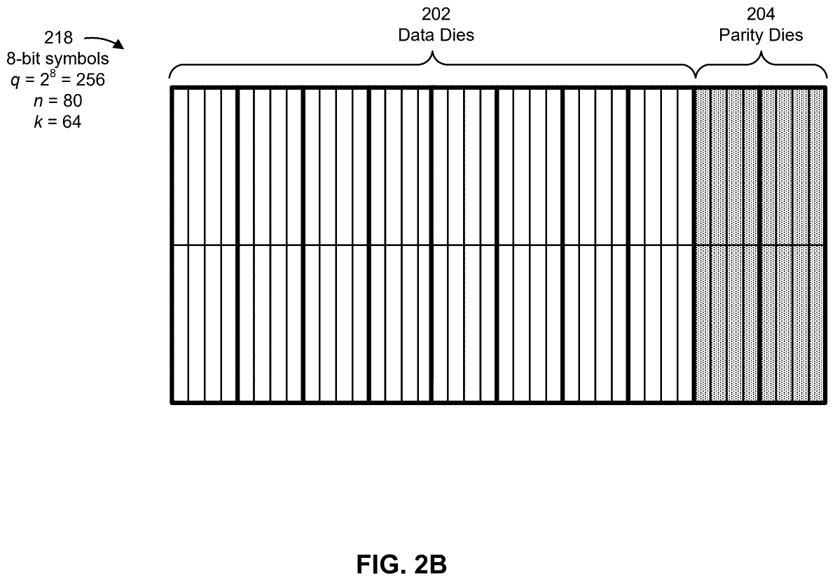

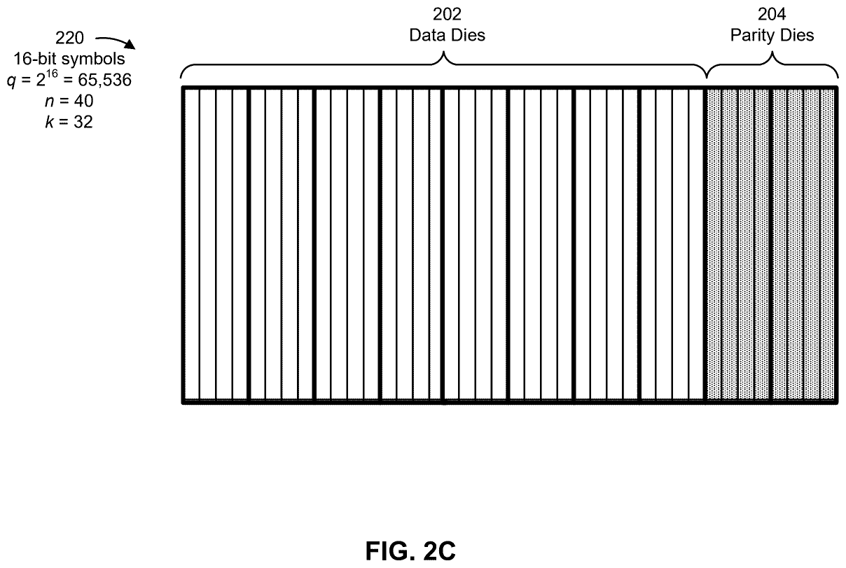

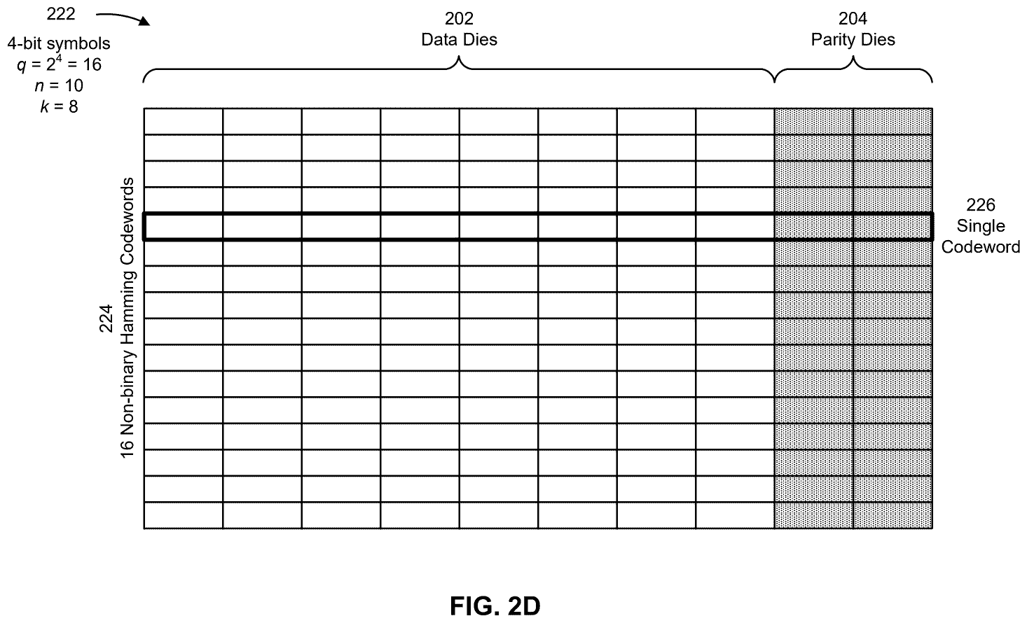

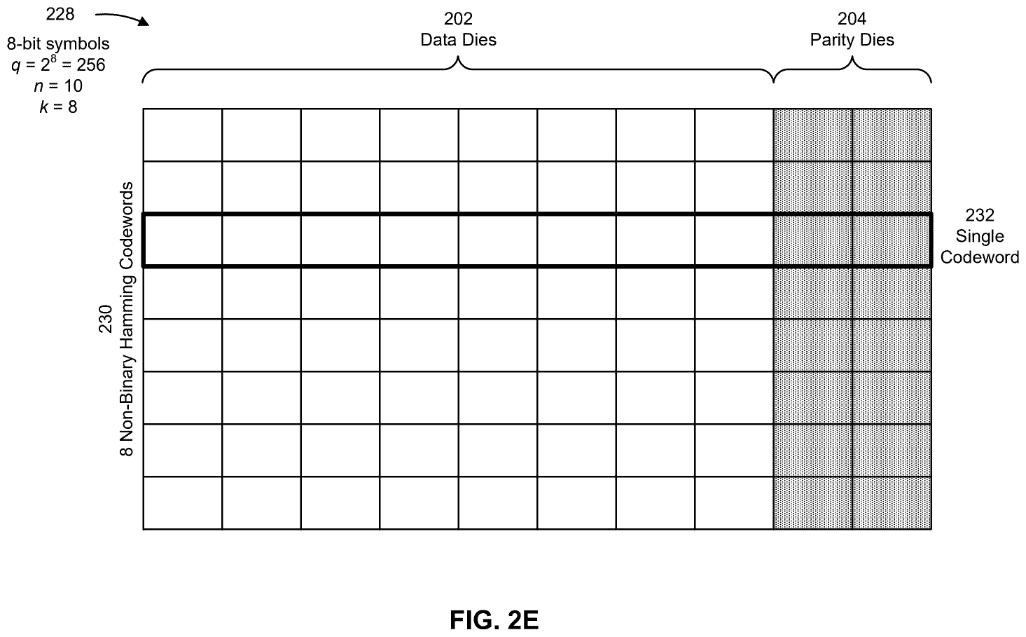

FIGS. 2A-2E are diagrams of examples associated with error correction codes used to provide memory die failure protection. The operations described in connection with FIGS. 2A-2E may be performed by the memory system 110 and/or one or more components of the memory system 110, such as the memory system controller 115, one or more memory devices 120, one or more local controllers 125, and/or one or more ECC engines associated with the memory system 110 and/or one more memory devices 120.

As shown in FIG. 2A, an ECC may be used in connection with a memory stripe 200 (sometimes referred to as a user data block, a data frame, a memory frame, and/or a similar term), which may correspond to a portion the volatile memory array 135 described above in connection with FIG. 1. In some examples, the memory stripe 200 may be associated with a memory channel (e.g., a data pathway between memory (e.g., DRAM) and other components of a memory device, such as a memory controller and/or a processor), with a “width” of the memory channel (e.g., measured in bits) referring to a quantity of bits that may be transferred in one operation and/or one memory cycle. For example, as described in more detail below, in some examples the memory stripe 200 may be associated with a 40-bit channel, and thus a memory device associated with the memory stripe 200 may be referred to as a 40-bit memory device. For example, the memory device may be a double data rate 5 (DDR5) 40-bit memory device, or a similar device.

The memory stripe 200 may be associated with multiple dies of memory used to store data bits and/or parity bits. Put another way, in some examples multiple data bits and/or parity bits may be striped across multiple dies associated with the memory stripe 200. For example, the memory stripe 200 is associated with ten dies (e.g., ten DRAM dies), indexed as Die 0 through Die 9, with Dies 0-7 used to store data bits (and thus referred to as data dies 202) and with Dies 8-9 used to store parity bits for error correction purposes (and thus referred to as parity dies 204). As indicated by reference number 206, the memory stripe 200 may be associated with a burst length of 16 (shown as BL16), such that, during each access of the memory stripe 200, sixteen bit lines (indexed 0 through 15) of each die may be transmitted in a channel. Moreover, as indicated by reference number 208, each die may be configured in a “by four” (×4) configuration, such that each die includes four input/output pins (sometimes referred to as data pins and/or DQ pins). In this regard, each die of the memory stripe 200 may be capable of storing 64 bits (e.g., 8 bytes). In some examples, the memory stripe 200 may be associated with 64 bytes of data (corresponding to the eight data dies 202, each capable of storing 8 bytes) and 16 bytes of parity (corresponding to the two parity dies 204, each capable of storing 8 bytes). Moreover, as indicated by reference number 210, the memory stripe 200 may be associated with a 40-bit channel, of which 32 bits may be associated with data bits (as indicated by reference number 212) and 8 bits may be associated with parity bits (as indicated by reference number 214). Accordingly, during each access of the memory stripe 200 by a memory controller, sixteen bursts (corresponding to the BL16) of 40 bits each (e.g., 32 bits of host data and 8 bits of parity data) may be transmitted via a channel (e.g., the 40-bit channel indicated by reference number 210).

In some examples, the parity dies 204 may store information that can be used in connection with an ECC to correct data, such as in an event in which an entire die fails. Put another way, an error correction system associated with the memory stripe 200 may be associated with a memory die failure protection scheme. For example, as indicated by reference number 216, in some events an entire die of a DRAM stack may fail (e.g., in the depicted example, Die 3 fails). In such cases, the parity bits stored in the parity dies 204 may be encoded in such a way that the parity bits may be used to recover data that is stored on the failed die.

More particularly, FIGS. 2B and 2C show examples in which the parity dies are associated with Reed-Solomon (RS) codes and/or in which the memory stripe 200 is associated with an RS memory die failure protection scheme. As shown in FIG. 2B, and as indicated by reference number 218, a memory die failure protection scheme may be obtained by using an RS code with 8-bit symbols. In such cases, a size of a symbol set (sometimes referred to as q) used in the RS coding scheme for the 40-bit memory stripe 200 may be equal to 256 (e.g., 2⁸), a length of an RS codeword (sometimes referred to as n) may be 80 symbols, and a length of the data portion of the RS codeword (sometimes referred to as k) may be 64 symbols (e.g., k=n−a quantity of symbols used for parity information, which is 16 in the example shown in FIG. 2B). In some examples, RS codes may be capable of correcting up to t symbols, with t being equal to

$$\frac{n - k}{2} .$$

Thus, for the 8-bit symbol example shown in FIG. 2B, the RS code may be capable of correcting up to

$$\frac{80 - 64}{2} = 8$$

symbols (e.g., 8 bytes), which is equivalent to an amount of data stored on one die. In this regard, the 8-bit RS code may be used to provide memory die failure protection in an event in which an entire die of the memory stripe 200 fails.

Similarly, as shown in FIG. 2C, and as indicated by reference number 220, a memory die failure protection scheme may be alternatively obtained by using an RS code with 16-bit symbols. In such cases, a size of a symbol set (e.g., q) used in the RS coding scheme for the 40-bit memory stripe 200 may be equal to 65,536 (e.g., 2¹⁶), a length of the RS codeword (e.g., n) may be 40 symbols, and a length of the data portion of the RS codeword (e.g., k) may be 32 symbols. Thus, the 16-bit symbol example may be capable of correcting up to 4 symbols (e.g.,

$$\frac{n - k}{2} = \frac{40 - 32}{2} = 4$$

symbols, or 8 bytes), which is equivalent to an amount of data stored on one die. In this regard, the 16-bit RS code may also be used to provide memory die failure protection in an event in which an entire die of the memory stripe 200 fails.

In some other examples, a non-binary Hamming (NBH) code may be used to provide memory die failure protection for a memory, such as the 40-bit memory stripe 200. In some examples, an NBH code used to provide memory die failure protection for a memory stripe may use q elements of a Galois field (GF) as its symbols (sometimes referred to as GF(q)) and/or may be associated with a redundancy r (e.g., the NBH code may use r parity symbols). In such examples, the non-binary Hamming code may be a linear code with a length N (e.g., a length of the code may include N symbols) and a dimension K (e.g., a dimension of the code may be K symbols), in which

$$N = \frac{{q}^{r} - 1}{q - 1}$$

and in which K=N−r. In some examples, NBH codes may be considered “perfect codes” in that NBH codes are capable of providing a most efficient error correction for a given set of parameters (e.g., an NBH code may correct errors within a certain radius without wasting any space on unnecessary redundancy). More particularly, NBH codes may be perfect codes with a minimum distance of three, in which a set of Hamming spheres of radius 1 centered in the codeword is a partition of an entire space of all possible patterns of N symbols in the alphabet GF(q), such that all space available to correct an error is exploited. In some examples, a primitive NBH code may be completely described by its parity check matrix H. In such examples, a column of H may be all the possible vectors of r symbols that are linearly independent of each other. That is,

$$H = [ \begin{matrix}1 & 0 & 1 & 1 & 1 & 1 & … & 1 & 1 \\ 0 & 1 & 1 & α & {α}^{2} & {α}^{3} & … & {α}^{q - 3} & {α}^{q - 2}\end{matrix} ] ,$$

in which α corresponds to a primitive element (e.g., an element that can generate all other non-zero elements of the finite field (e.g., GF(q)) through its powers).

As shown in FIG. 2D, and as indicated by reference number 222, in some examples a memory die failure protection scheme may use an NBH code with 4-bit symbols. In such cases, a size of a symbol set (e.g., q) used in an NBH coding scheme for the 40-bit memory stripe 200 may be equal to 16 (e.g., 2⁴), an effective length of an NBH codeword used for the memory stripe 200 (sometimes referred to herein as n) may be 10 symbols, and an effective dimension of the NBH codeword (e.g., a length of a data portion of single non-binary Hamming codeword, sometimes referred to herein as k) may be 8 symbols. In such examples, as shown by reference numbers 224 and 226, 16 NBH codewords may be used to provide memory die failure protection for the 40-bit memory stripe 200. Put another way, in examples implementing 4-bit symbols, there may be 16 NBH codewords per memory stripe 200, with each codeword covering one beat of a data burst (e.g., one of the sixteen data bursts associated with each access of the memory stripe 200).

Similarly, as shown in FIG. 2E, and as indicated by reference number 228, in some examples a memory die failure protection scheme may use an NBH code with 8-bit symbols. In such cases, a size of a symbol set (e.g., q) used in an NBH coding scheme for the 40-bit memory stripe 200 may be equal to 256 (e.g., 2⁸), an effective length of the NBH codeword (e.g., n) may be 10 symbols, and an effective dimension of the NBH codeword (e.g., k) may be 8 symbols. In such examples, as shown by reference number 230 and 232, 8 NBH codewords may be used to provide memory die failure protection for the 40-bit memory stripe 200. Put another way, in examples implementing 8-bit symbols, there may be 8 NBH codewords per memory stripe 200, with each codeword covering two beats of a data burst (e.g., two of the sixteen data bursts associated with each access of the memory stripe 200). In either case (e.g., an NBH code with 4-bit symbols or an NBH code with 8-bit symbols), each codeword contains no more than one symbol coming from each die. In that regard, because an NBH decoder is capable of correcting up to one symbol in a codeword, the NBH code memory die failure protection scheme has the capability to correct all of the symbols coming from a single die (e.g., the failed die).

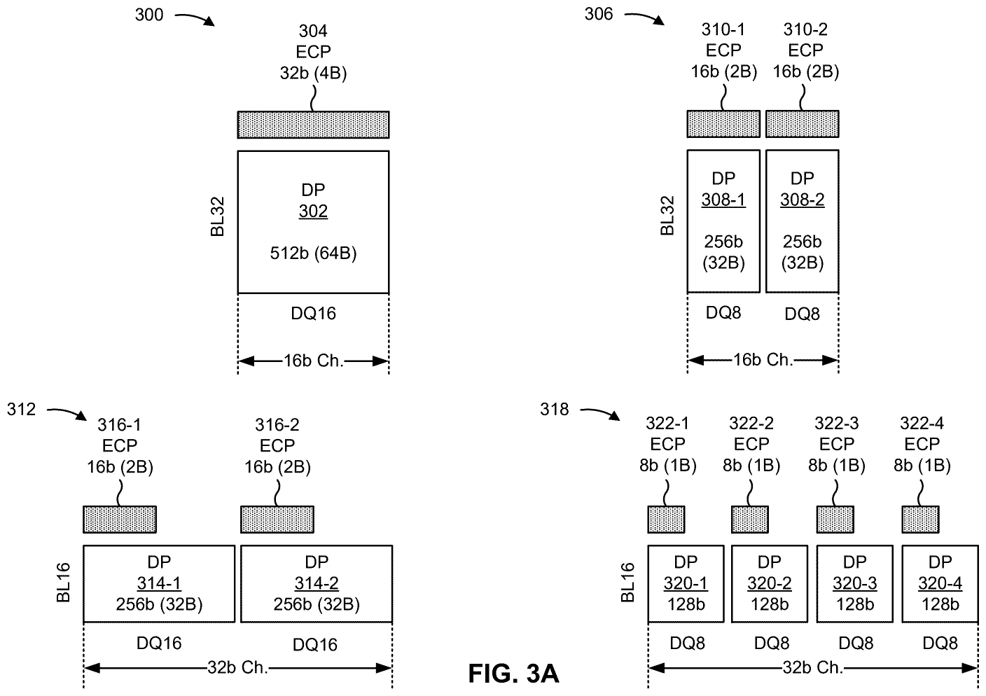

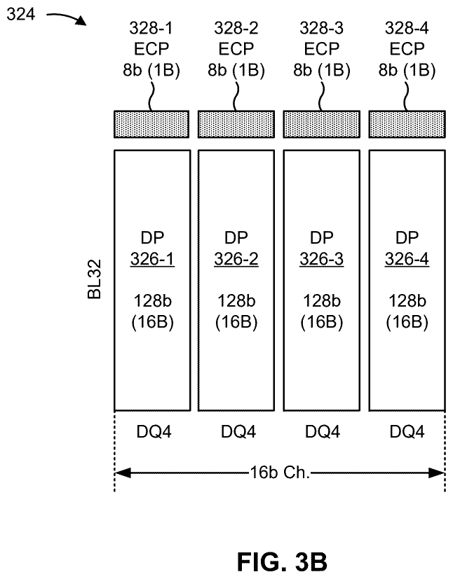

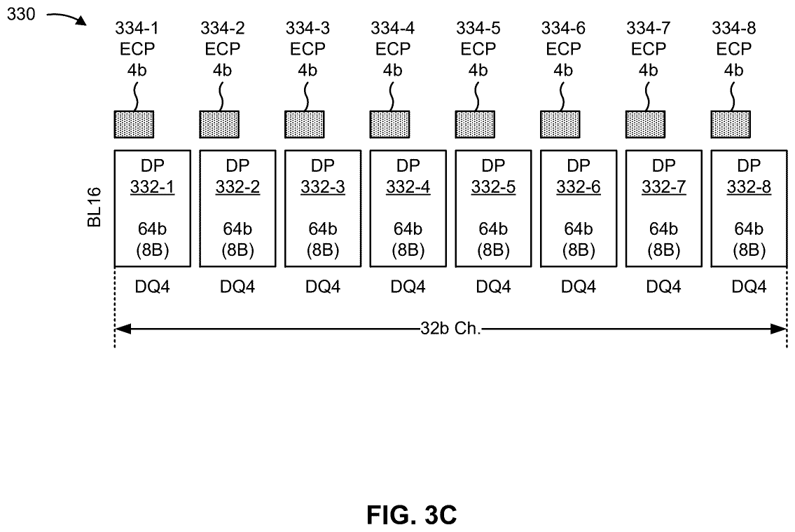

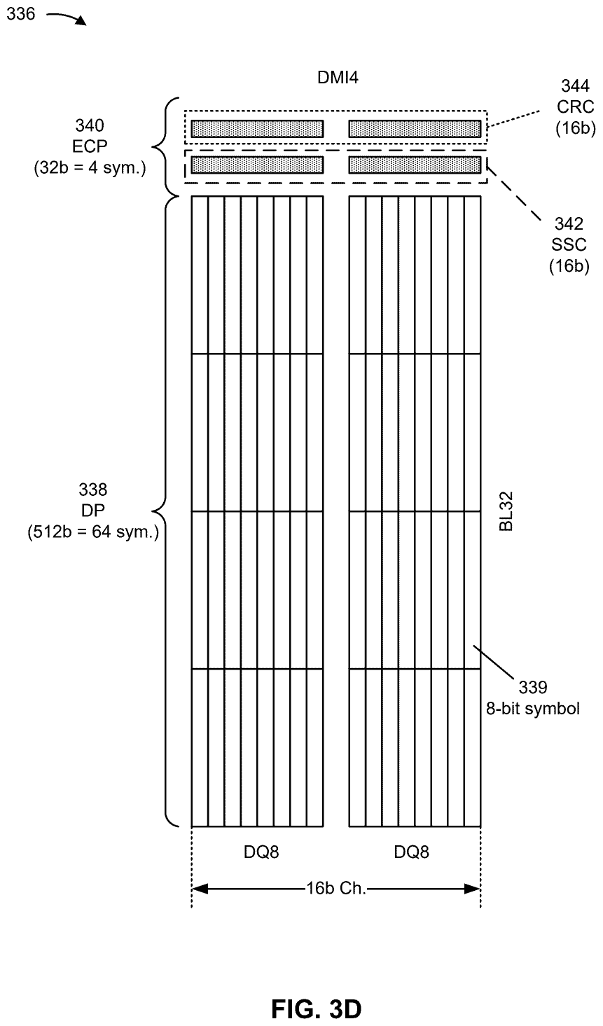

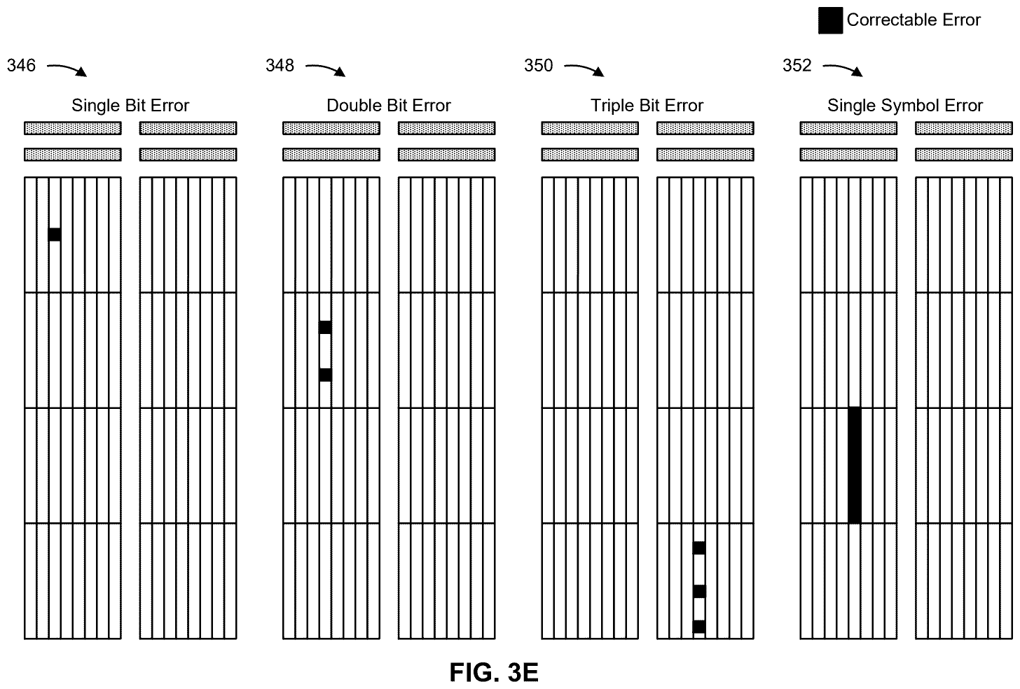

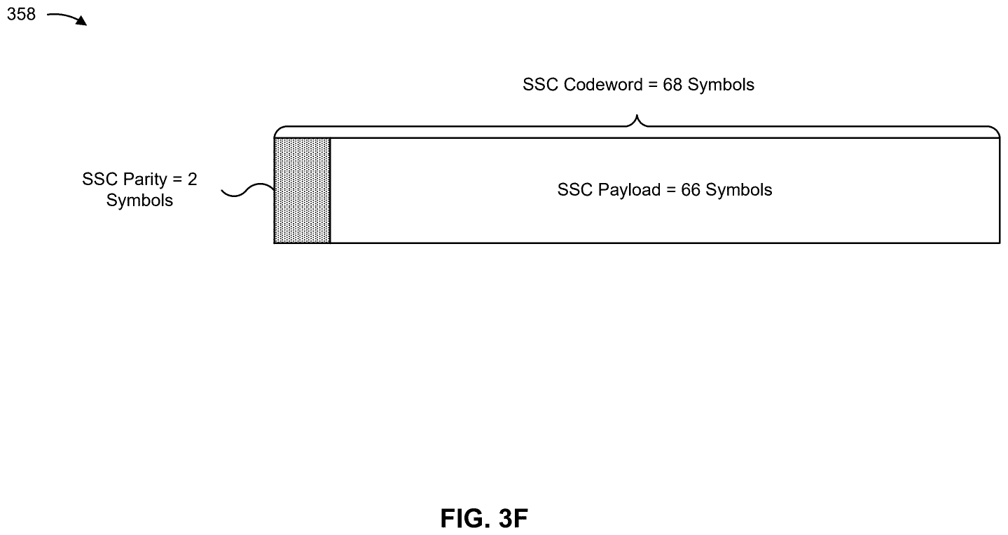

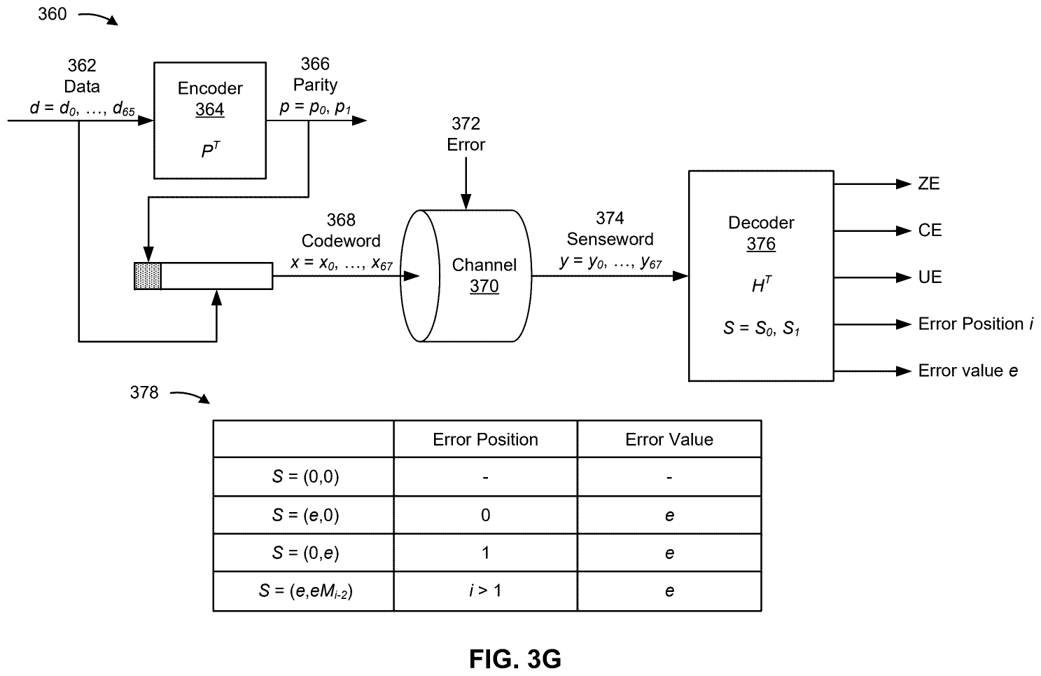

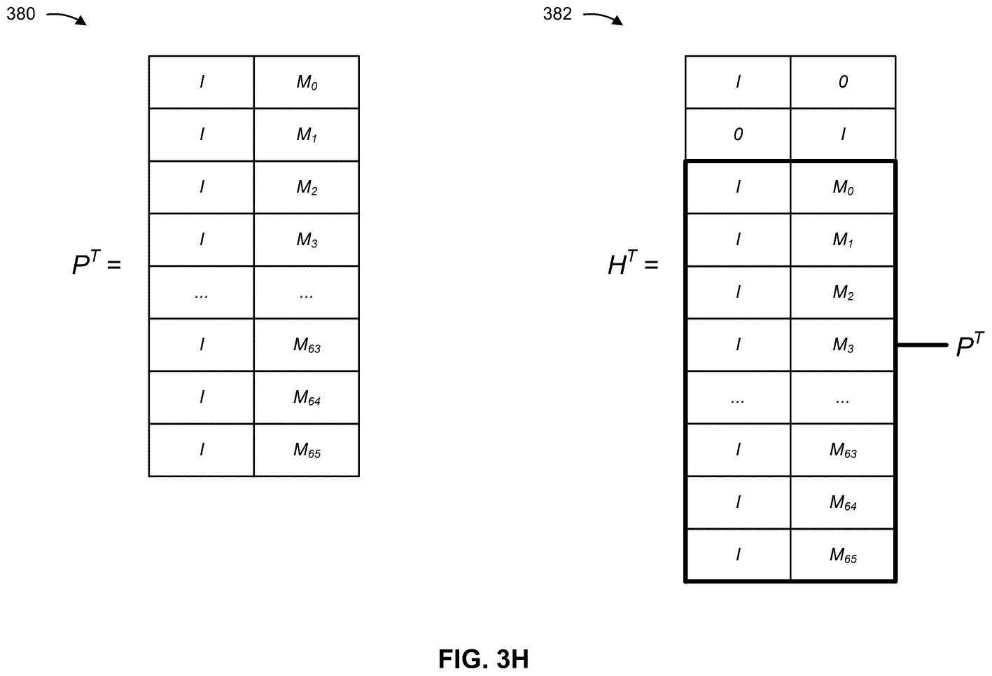

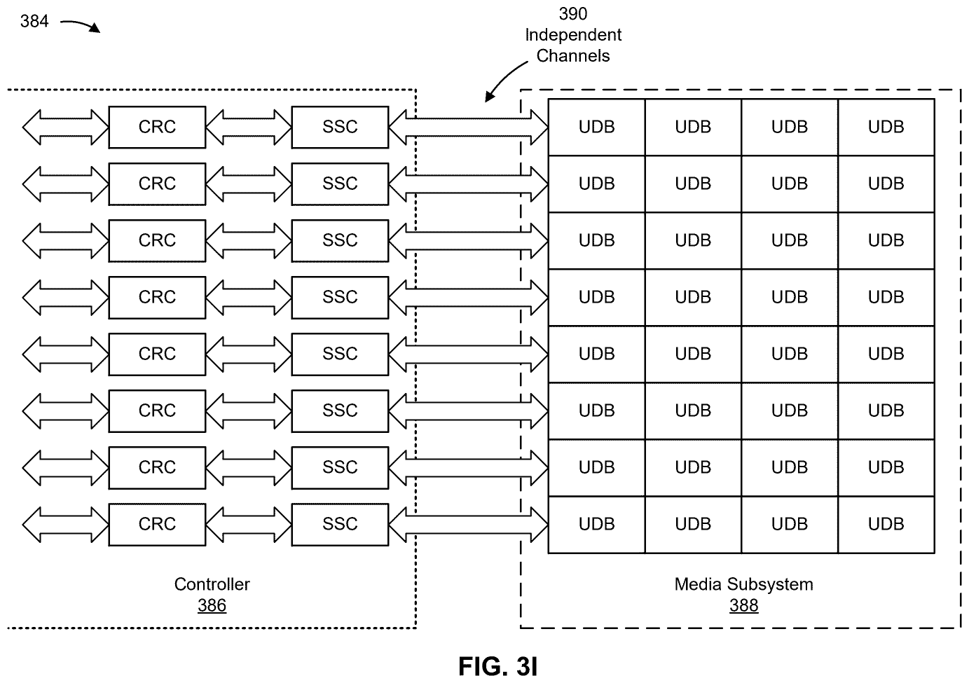

As described above, certain memory die failure protection schemes, such as the memory die failure protection schemes described above in connection with FIGS. 2B-2E, may result in die overprovisioning, reduced memory device performance (e.g., reduced bandwidth and/or increased latency), and high power consumption. Moreover, for certain applications, the reliability gain of memory die failure protection schemes may be unnecessary (e.g., certain applications may have less stringent reliability requirements than applications employing memory die failure protection schemes), such as AI and/or similar applications. Accordingly, in some implementations, a memory device may be capable of employing error detection and correction schemes that may not provide memory die failure protection but may nonetheless have a capability of correcting multi-bit errors in host data, thereby increasing a reliability of a memory device as compared to a device having no error correction capability and/or having a single error correction (SEC) capability, while reducing power consumption and/or improving performance of the memory device as compared to memory devices employing certain memory die failure protection schemes. Example error detection and correction schemes that may not provide memory die failure protection but may nonetheless have a capability of correcting multi-bit errors in host data are described in more detail below in connection with FIGS. 3A-3I.

As indicated above, FIGS. 2A-2E are provided as examples. Other examples may differ from what is described with regard to FIGS. 2A-2E.

FIGS. 3A-3I are diagrams of an examples associated with user data block error detection and correction. The operations described in connection with FIGS. 3A-3I may be performed by the memory system 110 and/or one or more components of the memory system 110, such as the memory system controller 115, one or more memory devices 120, and/or one or more local controllers 125.

FIG. 3A shows various UDBs for which implementations of the error detecting and correcting systems described herein may be employed. In some implementations, the UDBs shown in FIG. 3A may be associated a CXL compliant memory system, and/or may be used to store host data (sometimes referred to herein as user data) and/or error correction data and/or information (sometimes referred to herein as parity data) that may be accessed by a memory controller (e.g., memory system controller 115 and/or local controller 125), such as an ASIC of a CXL compliant memory system, and/or that may be provided in a packet (e.g., a CXL packet) during each access of the UDB. In some implementations, each UDB may include 512 bits (b) (e.g., 64 bytes (B)) of host data (and thus may be referred to herein as a 64B UDB) and/or 32 bits (e.g., 4 bytes) of parity data. In such implementations, the 64 bytes of host data may be stored in a data portion (DP) of the UDB and/or may be accessible via multiple data pins (e.g., DQ pins). Moreover, the 4 bytes of parity data may be stored in an error correction portion (ECP) of the UDB (sometimes referred to as a direct link ECC protocol (DLEP) area of the UDB) and/or may be accessible via multiple DMI pins. In that regard, during each access of the UDB shown in FIG. 3A, a memory controller (e.g., a CXL ASIC) may be capable of accessing, via a channel associated with the UDB, 64 bytes of host data via the DQ pins and 4 bytes of parity data via the DMI pins.

More particularly, FIG. 3A shows various arrangements of memory components that are configured in a by 8 mode (e.g., a mode in which 8 DQ pins are used to access the host data) or a by 16 mode (e.g., a mode in which 8 DQ pins are used to access the host data) that may be used to form the 64B UDB. In some implementations, the various UDBs shown in FIG. 3A may be associated with a low power double data rate 5 (LPDDR5) memory device.

As shown by reference number 300, in some implementations a 64B UDB may be formed using a single memory component. In such implementations, the UDB may include a DP 302 formed from a single memory component (e.g., a DRAM die) configured to operate in a by 16 mode (shown as DQ16) and/or with a burst length of 32 (shown as BL32), such that 16×32=512 bits (64 bytes) of host data may be accessible via the DQ pins for each access of the UDB. Moreover, the UDB may include an ECP 304 (e.g., a DLEP area) accessible in the channel via multiple DMI pins (e.g., 4 DMI pins) and/or which is capable of storing up to 4 bytes of parity data, such as up to 4 bytes of information associated with a single symbol correction (SSC) code and/or a cyclic redundancy check (CRC), among other information, which is described in more detail below. Accordingly, for each access of the UDB shown in connection with reference number 300, a memory controller (e.g., memory system controller 115 and/or local controller 125) may retrieve, via the channel, 64 bytes of host data using the DQ pins and 4 bytes of parity data using the DMI pins.

As shown by reference number 306, in some implementations a 64B UDB may be formed using multiple (e.g., two) memory components. In such implementations, the UDB may include a DP 308 formed from a multiple memory components (shown in FIG. 3A as a first DP 308-1 and a second DP 308-2, which may each be a DRAM die or a similar component) configured to operate in a by 8 mode (shown as DQ8) and/or with a burst length of 32 (e.g., BL32), such that 8×32=256 bits (32 bytes) of host data may be accessible from each component (for a total of 64 bytes) via the DQ pins for each access of the UDB. Moreover, the UDB may include an ECP 310 at each component (shown in FIG. 3A as a first ECP 310-1 and a second ECP 310-2, which may be a DLEP area at each DRAM die, or the like) accessible in the channel via multiple DMI pins (e.g., 4 DMI pins) and/or which are collectively capable of storing up to 4 bytes of parity data (e.g., 2 bytes at each component), such as up to 4 bytes of information associated with an SSC code and/or a CRC, among other information, which is described in more detail below. Accordingly, for each access of the UDB shown in connection with reference number 306, a memory controller (e.g., memory system controller 115 and/or local controller 125) may retrieve, via the channel, 64 bytes of host data using the DQ pins and 4 bytes of parity data using the DMI pins.

As shown by reference number 312, in some implementations a 64B UDB may be formed by multiple (e.g., two) memory components configured in a different manner than the memory components described above in connection with reference number 306. For example, the UDB may include a DP 314 formed from multiple memory components (shown in FIG. 3A as a first DP 314-1 and a second DP 314-2, which may each be a DRAM die or a similar component) configured to operate in a by 16 mode (e.g., DQ16) and/or with a burst length of 16 (e.g., BL16), such that 16×16=256 bits (32 bytes) of host data may be accessible from each component (for a total of 64 bytes) via the DQ pins for each access of the UDB. Moreover, the UDB may include an ECP 316 at each component (shown in FIG. 3A as a first ECP 316-1 and a second ECP 316-2, which may be a DLEP area at each DRAM die, or the like) accessible in the channel via multiple DMI pins (e.g., 4 DMI pins) and/or which are collectively capable of storing up to 4 bytes of parity data (e.g., 2 bytes at each component), such as up to 4 bytes of information associated with an SSC code and/or a CRC, among other information, which is described in more detail below. Accordingly, for each access of the UDB shown in connection with reference number 312, a memory controller (e.g., memory system controller 115 and/or local controller 125) may retrieve, via the channel, 64 bytes of host data using the DQ pins and 4 bytes of parity data using the DMI pins.

As shown by reference number 318, in some implementations a 64B UDB may be formed using a different quantity of memory components, such as by using four memory components. In such implementations, the UDB may include a DP 320 formed from multiple memory components (shown in FIG. 3A as a first DP 320-1 through a fourth DP 320-4) configured to operate in a by 8 mode (e.g., DQ8) and/or with a burst length of 16 (e.g., BL16), such that 8×16=128 bits (16 bytes) of host data may be accessible from each component (for a total of 64 bytes) via the DQ pins for each access of the UDB. Moreover, the UDB may include an ECP 322 at each component (shown in FIG. 3A as a first ECP 322-1 through a fourth ECP 322-4, which may be a DLEP area at each DRAM die, or the like) accessible in the channel via multiple DMI pins (e.g., 4 DMI pins) and/or which are collectively capable of storing up to 4 bytes of parity data (e.g., 1 byte at each component), such as up to 4 bytes of information associated with an SSC code and/or a CRC, among other information, which is described in more detail below. Accordingly, for each access of the UDB shown in connection with reference number 318, a memory controller (e.g., memory system controller 115 and/or local controller 125) may retrieve, via the channel, 64 bytes of host data using the DQ pins and 4 bytes of parity data using the DMI pins.

In some implementations, memory components may be configured in a by 4 mode (e.g., a mode in which 4 DQ pins are used to access the host data, sometimes referred to as DQ4). For example, FIGS. 3B and 3C show arrangements of memory components that are configured in a by 4 mode (e.g., DQ4) that may be used to form the 64B UDB. In some implementations, the UDBs shown in FIGS. 3B and 3C may be associated with a DDR5 memory device.

As shown in FIG. 3B, and as indicated by reference number 324, in some implementations a 64B UDB may be formed using four memory components operating in a by 4 mode (e.g., DQ4). More particularly, the UDB may include a DP 326 formed from multiple memory components (shown in FIG. 3B as a first DP 326-1 through a fourth DP 326-4) configured to operate in a by 4 mode (e.g., DQ4) and/or with a burst length of 32 (e.g., BL32), such that 4×32=128 bits (16 bytes) of host data may be accessible from each component (for a total of 64 bytes) via the DQ pins for each access of the UDB. Moreover, the UDB may include an ECP 328 at each component (shown in FIG. 3B as a first ECP 328-1 through a fourth ECP 328-4, which may be a DLEP area at each DRAM die, or the like) accessible in the channel via multiple DMI pins (e.g., 4 DMI pins) and/or which are collectively capable of storing up to 4 bytes of parity data (e.g., 1 byte at each component), such as up to 4 bytes of information associated with an SSC code and/or a CRC, among other information, which is described in more detail below. Accordingly, for each access of the UDB shown in connection with reference number 324, a memory controller (e.g., memory system controller 115 and/or local controller 125) may retrieve, via the channel, 64 bytes of host data using the DQ pins and 4 bytes of parity data using the DMI pins.

As shown in FIG. 3C, and as indicated by reference number 330, in some implementations a 64B UDB may be formed using eight memory components operating in a by 4 mode (e.g., DQ4). More particularly, the UDB may include a DP 332 formed from multiple memory components (shown in FIG. 3B as a first DP 332-1 through an eighth DP 332-8) configured to operate in a by 4 mode (e.g., DQ4) and/or with a burst length of 16 (e.g., BL16), such that 4×16=64 bits (8 bytes) of host data may be accessible from each component (for a total of 64 bytes) via the DQ pins for each access of the UDB. Moreover, the UDB may include an ECP 334 at each component (shown in FIG. 3B as a first ECP 334-1 through an eighth ECP 334-8, which may be a DLEP area at each DRAM die, or the like) accessible in the channel via multiple DMI pins (e.g., 8 DMI pins) and/or which are collectively capable of storing up to 4 bytes of parity data (e.g., 4 bits at each component), such as up to 4 bytes of information associated with an SSC code and/or a CRC, among other information, which is described in more detail below. Accordingly, for each access of the UDB shown in connection with reference number 330, a memory controller (e.g., memory system controller 115 and/or local controller 125) may retrieve, via the channel, 64 bytes of host data using the DQ pins and 4 bytes of parity data using the DMI pins.

In some implementations, using one of the memory architectures described above in connection with FIGS. 3A-3C or a similar architecture may enable multi-bit error correction for the respective UDBs. For example, one of the memory architectures described above in connection with FIGS. 3A-3C or a similar architecture may enable use of an SSC code and/or a CRC. In some implementations, in order to implement a SSC code and/or a CRC, a data stream (e.g., a stream of bits accessed a channel via the DQ pins and/or the DMI pins) may be partitioned into symbols, such as 8-bit symbols, among other examples. For example, FIG. 3D shows an example UDB 336 that may be partitioned into 8-bit symbols. The UDB 336 may include two memory components configured in a by 8 mode (e.g., DQ8) and having a burst length of 32 (e.g., BL32), such that the UDB 336 may have a substantially similar architecture as the UDB described above in connection with reference number 306. In some other implementations, a different memory architecture (e.g., a different one of the architecture described above in connection with FIG. 3A-3C or a similar architecture) may be partitioned into symbols (e.g., 8-bit symbols) without departing from the scope of the disclosure.

In this regard, a DP 338 of the UDB 336 may include 512 bits (64 bytes) of data, comprised of 64 8-bit symbols 339, which may be accessible via multiple DQ pins (e.g., 16 DQ pins). An ECP 340 of the UDB 336 (e.g., a DLEP area of the UDB) may include 32 bits (4 bytes) of data, comprised of four 8-bit symbols 339, which may be accessible via multiple DMI pins (e.g., 4 DMI pins, indicated in FIG. 3D as DMI4). In some implementations, a first part of the ECP 340 may be used to store SSC information, and/or a second part of the ECP 340 may be used to store CRC information. Put another way, the four 8-bit symbols of the ECP 340 may be divided into two classes, including a first class of symbols used for parity of the SSC code (indicated by reference number 342) and a second class of symbols used for parity of the CRC (indicated by reference number 344). In some implementations, the SSC may be implemented as an RS code correcting up to one symbol error or an NBH code using 8-bit symbols. In such implementations, the SSC code may require 16 parity bits, and thus may occupy two 8-bit symbols of the ECP 340, as indicated by reference number 342. The remaining part of the ECP 340 (e.g., the two 8-bit symbols, or 16 bits, remaining after allocating two symbols to the SSC code) may be used for the CRC. A CRC may have an error detection capability of

$$\frac{{2}^{b} - 1}{{2}^{b}} ,$$

with b corresponding to the quantity of bits used for the CRC. In such cases, when all remaining bits (e.g., 16 bits) in the ECP 340 are used for the CRC (as indicated by reference number 344), the CRC may have an error detection capability of

$$\frac{{2}^{16} - 1}{{2}^{16}} ,$$

or approximately 99.9985% (e.g., the CRC may be capable of detecting approximately 99.9985% of errors). In some other implementations, only a portion of bits remaining (e.g., 16 bits) in the ECP 340 after allocating bits to the SSC may be used for CRC (e.g., less than all of the 16 bits in the ECP 340 may be used for the CRC), and/or any remaining bits may be used for storing metadata associated with the UDB 336.

In such implementations (e.g., implementations in which the ECP 340 stores SSC information and CRC information), an error detection and/or correction scheme at a memory controller (e.g., an ECC engine operating at a memory controller) may comprise two steps. In a first step, an error correction process may be implemented by an SSC operation. In a second step, an error detection process may be implemented by a CRC operation. In such implementations, the data associated with the UDB 336 (e.g., the host data stored at the DP 338 and the error correction data (e.g., the SSC and/or CRC data) stored at the ECP 340) may be obtained by a single burst length 32 (e.g., BL32) access to 16-bit channel. More particularly, during a single access to the 16-bit channel, the host data (e.g., 64 bytes) may be accessed via the DQ pins (e.g., the 16 DQ pins) and the error correction data (e.g., 32 bits) may be accessed via the DMI pins (e.g., the 4 DMI pins). In the example shown in FIG. 3D, the error correction data may be partitioned into 16 bits of SSC bits, which may be used to correct up to one 8-bit symbol error, 16 bits of CRC bits (unless some bits are used to store and/or transmit metadata associated with the UDB 336, as described above), and/or one or more bits of metadata in implementations in which one or more bits in the ECP 340 are reserved to store metadata. In some implementations, the CRC data may belong to the payload of the SSC code. In such implementations, the CRC may be applied after processing at the memory controller (e.g., an ECC engine at the memory controller) by an SSC decoder.

In some other implementations, information associated with a different type of ECC (e.g., information associated with an ECC other than the SSC plus CRC implementation described above) may be stored in the ECP 340 and/or used to detect and/or correct multi-bit errors in the UDB 336. For example, in some implementations the ECP 340 may be used to store data associated with a Bose-Chaudhuri-Hocquenghem (BCH) code that is capable of correcting up to 3-bit errors (sometimes referred to as BCH3). In such implementations, 30 bits of the 32 bits available in the ECP 340 may be used to store BCH3 information (e.g., parity information associated with the BCH3 code), with the remaining two bits being used for metadata and/or an additional error detection mechanism (e.g., a 2-bit CRC, single parity bits, and/or the like). In some other implementations, the ECP 340 may be used to store data associated with a BCH code that is capable of correcting up to 2-bit errors (sometimes referred to as BCH2). In such implementations, 20 bits of the 32 bits available in the ECP 340 may be used to store BCH2 information (e.g., parity information associated with the BCH2 code), with the remaining 12 bits being used for CRC, or else being partitioned into CRC bits and metadata bits. In some other implementations, the ECP 340 may be used to store data associated with an RS code that is capable of correcting up to two 8-bit symbol errors (sometimes referred to as RS2). In such implementations, the RS2 code may need four symbols of parity, and thus all of the 32 bits available in the ECP 340 may be used to store RS2 information (e.g., parity information associated with the RS2 code), with no bits being used for a CRC, metadata, or the like.

By using the ECP 340 to store SSC information, BHC3 information, BHC2 information, RS2 information, and/or CRC information in this manner, multi-bit errors may be detected and/or corrected without implementing a resource-intensive memory die failure protection scheme. For example, as shown in FIG. 3E, and as indicated by reference number 346, one or more of the ECCs described above (e.g., the SSC code such as the RS code and/or the NBH code, the BH2 code, the BH3 code, and/or the RS2 code) may be capable of detecting and/or correcting single bit errors in the UDB. Additionally, or alternatively, as indicated by reference number 348, one or more of the ECCs described above (e.g., the SSC code such as the RS code and/or the NBH code, the BH2 code, the BH3 code, and/or the RS2 code) may be capable of correcting a double bit error in the UDB, such as in cases in which both errors are within the same symbol (e.g., the same 8-bit symbol 339). Additionally, or alternatively, as indicated by reference number 350, one or more of the ECCs described above (e.g., the SSC code such as the RS code and/or the NBH code, the BH3 code, and/or the RS2 code) may be capable of correcting a triple bit error in the UDB, such as in cases in which all three errors are within the same symbol (e.g., the same 8-bit symbol 339). Additionally, or alternatively, as indicated by reference number 352, one or more of the ECCs described above (e.g., the SSC code such as the RS code and/or the NBH code, and/or the RS2 code) may be capable of correcting a single symbol error in the UDB (e.g., an error associated with an same 8-bit symbol 339). In some implementations, the RS2 code described above may be capable of correcting even additional errors, such as up to two 8-bit symbol errors (not shown).

FIG. 3F depicts an SSC codeword 358 that may be used in connection with an NBH code, as one example of an SSC code that may be used to provide error detection and correction protection for a UDB, such as the UDB 336 described above in connection with FIG. 3D. In such implementations, there may be 68 symbols (e.g., 68 8-bit symbols) accessible via a single access of the UDB (e.g., 64 host data symbols accessible via the DQ pins and 4 error correction symbols accessible via the DMI pins). Accordingly, the SSC codeword 358 may include 68 symbols. Moreover, as described above, in such implementations the CRC information may belong to the payload of the SSC code. Accordingly, the payload of the SSC codeword may be 66 symbols (e.g., 64 host data symbols and 2 CRC symbols), with the remaining 2 symbols of the SSC codeword 358 being associated with the SSC code parity.

FIG. 3G depicts an example 360 associated with encoding and decoding a codeword associated with an NBH code, such as in implementations in which an SSC code and/or a CRC is implemented to provide error detection and/or correction protection for a UDB (e.g., the UDB 336). As shown by reference number 362, a data vector (d) may be provided to an encoder 364 in order to encode a parity vector (p). As described above in connection with SSC codeword 358, the data vector, which corresponds to the payload of the SSC codeword 358, may include 66 symbols, shown in the example 360 as d₁ through d₆₅. The encoder 364 may multiply the data vector by a transpose of a parity matrix (P^{T}) to determine the parity vector, which in this implementation may include two symbols shown as p₀ and p₁, as indicated by reference number 366. In some implementations,

$$P = [ \begin{matrix}1 & 1 & 1 & … & 1 \\ 1 & α & {α}^{2} & … & {α}^{65}\end{matrix} ] ,$$

with 1 and aⁱ (i=1, . . . , 65) corresponding to 8×8 binary matrices. Put another way, the parity matrix (e.g., P) may be defined by 66 matrices Mᵢ (i=0, . . . , 65) of size 8×8, such that

$${P}^{T} = [ \begin{matrix}I & {M}_{0} \\ … & … \\ I & {M}_{65}\end{matrix} ] ,$$

as shown by reference number 380 in FIG. 3H. In some implementations, the encoder 364 may include a tree of an exclusive or (XOR) network with gates and connections defined by the parity matrix (e.g., P).

As shown by reference number 368, the parity vector (e.g., p) may be combined with the data vector (e.g., d) to form a codeword (x), which may correspond to the SSC codeword 358. In that regard, the codeword (e.g., x) may comprise 68 symbols (shown in the example 360 as x₀ through x₆₇), including the two parity symbols (e.g., p₀ and p₁) and 66 data symbols (e.g., d₀, . . . , d₆₅). When a memory device controller accesses the host data of the UDB, the codeword may be transmitted to the controller via a channel 370, which may correspond to the 16-bit channel described above in connection with the UDB 336. Due to noise and/or other factors associated with the channel 370, one or more errors may be introduced to the codeword, as indicated by reference number 372. Accordingly, a senseword (y) that arrives at a controller, which may similarly include 68 symbols (shown in FIG. 3G as y₀ through y₆₇), may differ from the codeword (e.g., x) provided to the channel 370. Put another way, due to noise or the like, an output of the channel 370 (e.g., y) may be different from an input of the channel 370 (e.g., x).

As indicated by reference number 374, the senseword (e.g., y) may be provided to a decoder 376. The decoder 376 may multiply the senseword by a transpose of a parity check matrix (H^{T}) to determine a syndrome vector(S), which in this implementation may include two symbols shown as S₀ and S₁. In some implementations,

$$H = [ \begin{matrix}1 & 0 & 1 & 1 & 1 & … & 1 \\ 0 & 1 & 1 & α & {α}^{2} & … & {α}^{65}\end{matrix} ] = [ \begin{matrix}I & P\end{matrix} ] .$$

Put another way, the parity check matrix (e.g., H) may be defined by 66 matrices Mᵢ (i=0, . . . , 65) of size 8×8, such that

$${H}^{T} = [ \begin{matrix}I \\ {P}^{T}\end{matrix} ] ,$$

as shown by reference number 382 in FIG. 3H. In some implementations, the syndrome may be used by the decoder 376 to determine if the senseword (e.g., y) contains any errors, and, if so, a position of the error and/or a value of the error.

More particularly, using the syndrome, the decoder 376 may be capable of identifying that the senseword includes zero errors (ZE), a correctable error (CE), and/or an uncorrectable error (UE). Moreover, in instances in which the decoder 376 identifies an error, the decoder 376 may be capable of identifying an error position (shown as i, which may correspond to an index of a symbol in the senseword containing an error, and thus i∈[0,67]), and/or an error value (shown as e, which represents an 8-bit value). As indicated by reference number 378, following computation of the syndrome (e.g., S), the decoder 376 may perform syndrome pattern recognition to identify a position and/or value of any errors in the senseword. For example, if S=[0,0], then the decoder 376 may identify that the senseword includes zero errors (e.g., ZE). If S=[e,0], then the decoder 376 may identify that the senseword includes one error of value e in the first parity symbol, sometimes denoted as p₀′ to distinguish from the encoded value p₀ (e.g., the decoder may determine that the senseword includes a correctable error (e.g., CE) in the first parity symbol (e.g., p₀′). If S=[0,e], then the decoder 376 may identify that the senseword includes one error of value e in the second parity symbol, sometimes denoted as p₁′ to distinguish from the encoded value p₁ (e.g., the decoder may determine that the senseword includes a correctable error (e.g., CE) in the second parity symbol (e.g., p₁)). If S=[e,eαᵢ], with i∈[0,65], then the decoder 376 may identify that the senseword includes one error of value e in a data symbol indexed as i, sometimes denoted as d′ to distinguish from the encoded value dᵢ (e.g., the decoder may determine that the senseword includes a correctable error (e.g., CE) in a data symbol d′). Otherwise, the decoder 376 may identify that the senseword includes an uncorrectable error (e.g., UE).

As shown in FIG. 3I, and as indicated by reference number 384, in some implementations a controller 386 may include an encoder (e.g., encoder 364) and decoder (e.g., decoder 376) pair for each channel of a media subsystem 388. More particularly, the media subsystem 388 may be associated with eight independent channels 390, each corresponding to four UDBs (e.g., the media subsystem 388 may include four ranks, such that the controller 386 is configured to access one of four UDBs at a time via each of the independent channels 390). In such implementations, the controller may include eight encoder/decoder pairs, one for each independent channel 390. Accordingly, each codeword obtained from the media subsystem 388 via an independent channel 390 may be provided to a corresponding encoder/decoder pair, such as for a purpose of identifying and/or correcting errors in the codeword (e.g., via use of an SSC code, a CRC, and/or the like, as described above).

As indicated above, FIGS. 3A-3I are provided as an example. Other examples may differ from what is described with regard to FIGS. 3A-3I.

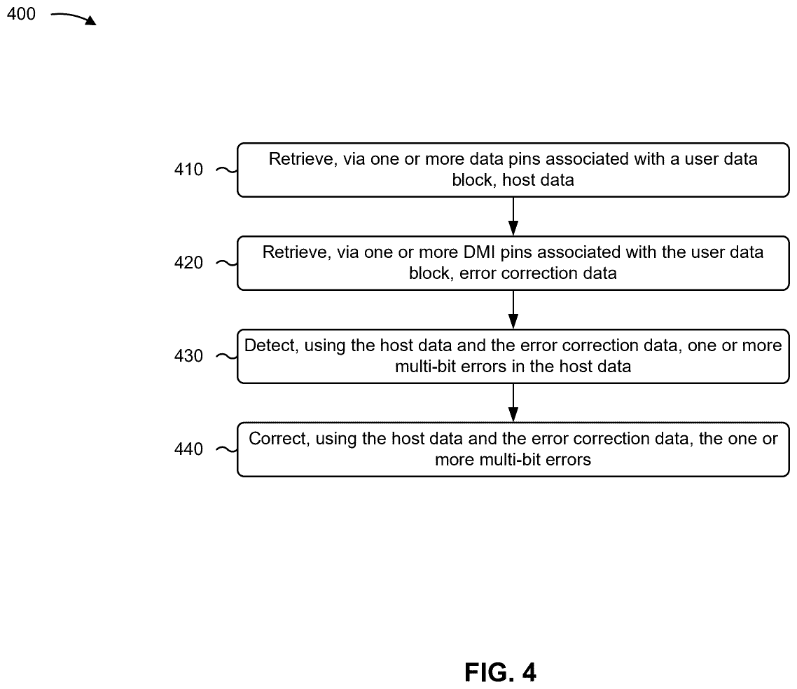

FIG. 4 is a flowchart of an example method 400 associated with user data block error detection and correction. In some implementations, a memory device (e.g., the memory device 120) may perform or may be configured to perform the method 400. In some implementations, another device or a group of devices separate from or including the memory device (e.g., the system 100) may perform or may be configured to perform the method 400. Additionally, or alternatively, one or more components of the memory device (e.g., the memory system controller 115, the local controller 125, and/or the memory array 130) may perform or may be configured to perform the method 400. Thus, means for performing the method 400 may include the memory device and/or one or more components of the memory device. Additionally, or alternatively, a non-transitory computer-readable medium may store one or more instructions that, when executed by the memory device (e.g., the local controller 125 of the memory device 120), cause the memory device to perform the method 400.

As shown in FIG. 4, the method 400 may include retrieving, via one or more data pins associated with a user data block, host data (block 410). For example, a memory device controller may retrieve host data stored in the DP 338 of the UDB 336 via the 16 DQ pins, as described above in connection with FIG. 3D, which may be retrieved as a portion of a data vector (e.g., d) of a codeword, such as the SSC codeword described above in connection with FIG. 3F.

As further shown in FIG. 4, the method 400 may include retrieving, via one or more DMI pins associated with the user data block, error correction data (block 420). For example, the memory device controller may retrieve error correction stored in the ECP 340 of the UDB 336 via the 4 DMI pins, as described above in connection with FIG. 3D, which may be retrieved as a portion of a data vector (e.g., d) of a codeword and/or a parity vector of a codeword, such as the SSC codeword described above in connection with FIG. 3F. More particularly, in implementations utilizing an SSC code (e.g., a NBH code) and a CRC, the CRC information may be retrieved as part of the data vector of the codeword and/or the SSC information may be retrieved as part of the parity vector of the codeword, as described above in connection with FIGS. 3F-3H.

As further shown in FIG. 4, the method 400 may include detecting, using the host data and the error correction data, one or more multi-bit errors in the host data (block 430). For example, as described above in connection with FIGS. 3G and 3H, the memory device controller may detect up to an 8-bit symbol error by determining a syndrome from a senseword and/or identifying a pattern in the syndrome associated with a correctable error, as described above in connection with FIG. 3G. As further shown in FIG. 4, the method 400 may include correcting, using the host data and the error correction data, the one or more multi-bit errors (block 440). For example, the memory device controller may correct up to an 8-bit symbol error such as by using an identified location of the error in the senseword (e.g., i) and/or by using an identified error value in the senseword (e.g., e), as described above in connection with FIG. 3G.

The method 400 may include additional aspects, such as any single aspect or any combination of aspects described below and/or described in connection with one or more other methods or operations described elsewhere herein.

In a first aspect, a host data portion of the user data block that is used to store the host data includes 64 bytes of storage, and an error correction portion of the user data block that is used to store the error correction data includes 4 bytes of storage. For example, the user data block may be associated with one of the architectures described above in connection with FIGS. 3A through 3D, in which a corresponding DP includes 64 bytes of data and the corresponding ECP includes 4 bytes of data.

In a second aspect, alone or in combination with the first aspect, the user data block is associated with one of 16 data pins, each providing 32 bits of host data per user data block access, or 32 data pins, each providing 16 bits of host data per user data block access, and four DMI pins, each providing 8 bits of error correction data per user data block access. For example, the user data block may be associated with one of the architectures described above in connection with FIGS. 3A through 3D, in which the corresponding DPs include one component configured in a DQ16 and BL32 mode, two components configured in a DQ8 and BL32 mode, two components configured in a DQ16 and BL16 mode, four components configured in a DQ8 and BL16 mode, four components configured in a Dq4 and BL32 mode, and/or eight components configured in a DQ4 and BL16 mode. Additionally, or alternatively, the user data block may be associated with one of the architectures described above in connection with FIGS. 3A through 3D, in which four DMI pins are configured to access 32 bits of error correction data stored in an ECP of one or more components.

In a third aspect, alone or in combination with one or more of the first and second aspects, the host data is associated with multiple data symbols, and the error correction data is associated with an SSC code. For example, the host data may be associated with 8-bit symbols (e.g., the 8-bit symbols 339 described above in connection with FIG. 3D), and the error correction data may store parity information associated with an SSC code, such as an RS code, a NBH code, or a similar code.

In a fourth aspect, alone or in combination with one or more of the first through third aspects, the SSC code is one of a Reed-Solomon code or a non-binary Hamming code.

In a fifth aspect, alone or in combination with one or more of the first through fourth aspects, the SSC is the non-binary Hamming code, the host data and the error correction data form part of a 68 symbol codeword that includes 66 payload symbols and 2 parity symbols, and the 66 payload symbols include 64 host data symbols and 2 cyclic redundancy check symbols. For example, the host data and the error correction data may form part of the SSC codeword 358 described above in connection with FIG. 3F.

In a sixth aspect, alone or in combination with one or more of the first through fifth aspects, the error correction data is further associated with a cyclic redundancy check.

In a seventh aspect, alone or in combination with one or more of the first through sixth aspects, the method 400 includes retrieving, by the memory device via the one or more DMI pins, metadata associated with the user data block. For example, as described above in connection with FIG. 3D, in some implementations the ECP 340 may be used to store one or more metadata bits. In such implementations, the memory device controller may be configured to retrieve the metadata from the ECP 340 using the DMI pins.

In an eighth aspect, alone or in combination with one or more of the first through seventh aspects, the error correction data is associated with a Bose-Chaudhuri-Hocquenghem code capable of correcting at least a two-bit error. For example, as described above in connection with FIGS. 3D-3E, in some implementations the error correction data may include data associated with a BCH2 code or a BCH3 code.

In a ninth aspect, alone or in combination with one or more of the first through eighth aspects, detecting the one or more multi-bit errors in the host data comprises computing, using the host data and the error correction data, a syndrome, and determining a pattern associated with the one or more multi-bit errors. For example, the memory device controller may detect the syndrome (e.g., S) described above in connection with FIG. 3G, and/or may identify an error in the senseword (e.g., y) such as by recognizing one of the patterns described above in connection with the table indicated by reference number 378.

Although FIG. 4 shows example blocks of a method 400, in some implementations, the method 400 may include additional blocks, fewer blocks, different blocks, or differently arranged blocks than those depicted in FIG. 4. Additionally, or alternatively, two or more of the blocks of the method 400 may be performed in parallel. The method 400 is an example of one method that may be performed by one or more devices described herein. These one or more devices may perform or may be configured to perform one or more other methods based on operations described herein.

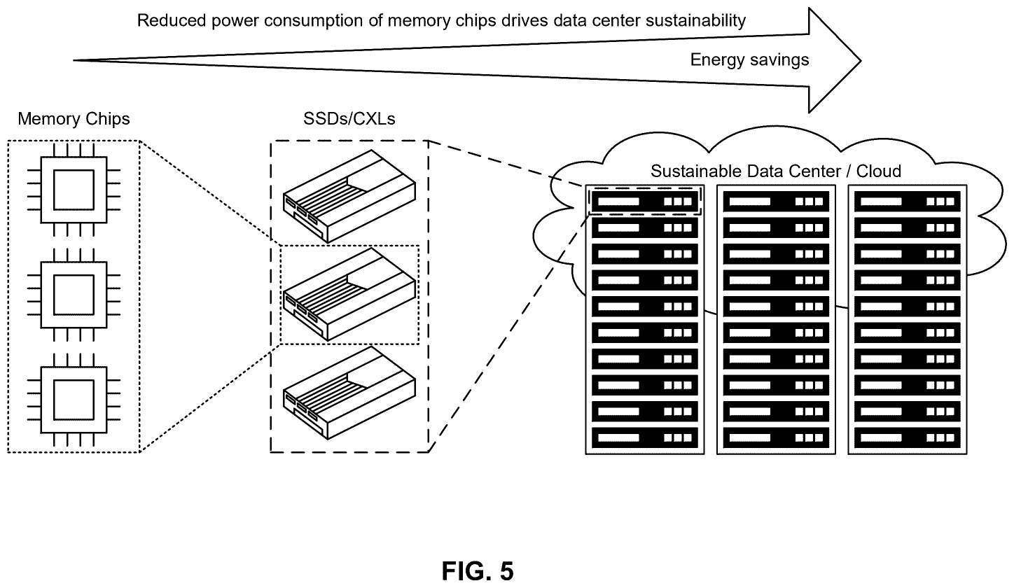

FIG. 5 is a diagram illustrating example systems in which the memory device 120 described herein may be used. In some implementations, one or more memory devices 120 may be included in a memory chip. Multiple memory chips may be packaged together and included in a higher level system, such as an SSD, a CXL compliant memory system (referred the herein simply as CXLs), or another type of memory drive. Each SSD, CXL, or other memory drive may include, for example, up to five memory chips, up to ten memory chips, or more. A data center or cloud computing environment may include multiple SSDs, CXLs, and/or other memory drives to store a large amount of data. For example, a data center may include hundreds, thousands, or more SSDs, CXLs, and/or other memory drives.

As described above, some implementations described herein reduce power consumption of a memory device 120. As shown in FIG. 5, this reduced power consumption drives data center sustainability and leads to energy savings because of the large volume of memory devices 120 included in a data center.

As indicated above, FIG. 5 is provided as an example. Other examples may differ from what is described with regard to FIG. 5.

In some implementations, a memory device includes one or more components configured to: retrieve, via one or more data pins associated with a user data block, host data; retrieve, via one or more DMI pins associated with the user data block, error correction data; detect, using the host data and the error correction data, one or more multi-bit errors in the host data; and correct, using the host data and the error correction data, the one or more multi-bit errors.

In some implementations, a method includes retrieving, by a memory device and via one or more data pins associated with a user data block, host data; retrieving, by the memory device and via one or more DMI pins associated with the user data block, error correction data; detecting, by the memory device and using the host data and the error correction data, one or more multi-bit errors in the host data; and correcting, by the memory device and using the host data and the error correction data, the one or more multi-bit errors.

In some implementations, a memory system includes a media subsystem organized into multiple user data blocks; and a memory controller in communication with the media subsystem via multiple channels, wherein each of the multiple channels corresponds to a respective user data block, of the multiple user data blocks, and wherein the memory controller is configured to, for each user data block, of the multiple user data blocks: retrieve, via one or more data pins associated with the user data block, host data; retrieve, via one or more DMI pins associated with the user data block, error correction data; detect, using the host data and the error correction data, one or more multi-bit errors in the host data; and correct, using the host data and the error correction data, the one or more multi-bit errors.

The foregoing disclosure provides illustration and description but is not intended to be exhaustive or to limit the implementations to the precise forms disclosed. Modifications and variations may be made in light of the above disclosure or may be acquired from practice of the implementations described herein.

As used herein, the terms “substantially” and “approximately” mean “within reasonable tolerances of manufacturing and measurement.” As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

When “a component” or “one or more components” (or another element, such as “a controller” or “one or more controllers”) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that d₀ not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. A memory device, comprising:
one or more components configured to:
retrieve, via one or more data pins associated with a user data block, host data;
retrieve, via one or more data mask inversion (DMI) pins associated with the user data block, error correction data;
detect, using the host data and the error correction data, one or more multi-bit errors in the host data; and
correct, using the host data and the error correction data, the one or more multi-bit errors.

2. The memory device of claim 1, wherein a host data portion of the user data block that is used to store the host data includes 64 bytes of storage, and
wherein an error correction portion of the user data block that is used to store the error correction data includes 4 bytes of storage.

3. The memory device of claim 1, wherein the user data block is associated with:
one of 16 data pins, each providing 32 bits of host data per user data block access, or 32 data pins, each providing 16 bits of host data per user data block access, and
four DMI pins, each providing 8 bits of error correction data per user data block access.

4. The memory device of claim 1, wherein the host data is associated with multiple data symbols, and
wherein the error correction data is associated with a single symbol correction (SSC) code.

5. The memory device of claim 4, wherein the SSC code is one of a Reed-Solomon code or a non-binary Hamming code.

6. The memory device of claim 5, wherein the SSC is the non-binary Hamming code,
wherein the host data and the error correction data form part of a 68 symbol codeword that includes 66 payload symbols and 2 parity symbols, and
wherein the 66 payload symbols include 64 host data symbols and 2 cyclic redundancy check symbols.

7. The memory device of claim 4, wherein the error correction data is further associated with a cyclic redundancy check.

8. The memory device of claim 1, wherein the one or more components are further configured to retrieve, via the one or more DMI pins, metadata associated with the user data block.

9. The memory device of claim 1, wherein the error correction data is associated with a Bose-Chaudhuri-Hocquenghem code capable of correcting at least a two-bit error.

10. The memory device of claim 1, wherein the one or more components, to detect the one or more multi-bit errors in the host data, are configured to:
compute, using the host data and the error correction data, a syndrome; and
determine, using the syndrome, a pattern associated with the one or more multi-bit errors.

11. A method, comprising:
retrieving, by a memory device and via one or more data pins associated with a user data block, host data;
retrieving, by the memory device and via one or more data mask inversion (DMI) pins associated with the user data block, error correction data;
detecting, by the memory device and using the host data and the error correction data, one or more multi-bit errors in the host data; and
correcting, by the memory device and using the host data and the error correction data, the one or more multi-bit errors.

12. The method of claim 11, wherein the host data is associated with multiple data symbols, and
wherein the error correction data is associated with a single symbol correction (SSC) code.

13. The method of claim 12, wherein the SSC code is one of a Reed-Solomon code or a non-binary Hamming code.

14. The method of claim 12, wherein the error correction data is further associated with a cyclic redundancy check.

15. The method of claim 11, further comprising retrieving, by the memory device via the one or more DMI pins, metadata associated with the user data block.

16. The method of claim 11, wherein detecting the one or more multi-bit errors in the host data comprises:
computing, by the memory device and using the host data and the error correction data, a syndrome; and
determining, by the memory device using the syndrome, a pattern associated with the one or more multi-bit errors.

17. A memory system, comprising:
a media subsystem organized into multiple user data blocks; and
a memory controller in communication with the media subsystem via multiple channels, wherein each of the multiple channels corresponds to a respective user data block, of the multiple user data blocks, and wherein the memory controller is configured to, for each user data block, of the multiple user data blocks:
retrieve, via one or more data pins associated with the user data block, host data;
retrieve, via one or more data mask inversion (DMI) pins associated with the user data block, error correction data;
detect, using the host data and the error correction data, one or more multi-bit errors in the host data; and
correct, using the host data and the error correction data, the one or more multi-bit errors.

18. The memory system of claim 17, wherein each user data block includes:
a host data portion that is used to store the host data and that includes 64 bytes of storage, and
an error correction portion that is used to store the error correction data and that includes 4 bytes of storage.

19. The memory system of claim 17, wherein each user data block is associated with:
one of 16 data pins, each providing 32 bits of host data per user data block access, or 32 data pins, each providing 16 bits of host data per user data block access, and
four DMI pins, each providing 8 bits of error correction data per user data block access.

20. The memory system of claim 17, wherein, for each user data block:
the host data is associated with multiple data symbols, and
the error correction data is associated with a single symbol correction (SSC) code.
